(19) United States
(12) Patent Application Publication
(10) Pub. No.: US 2018/0023468 A1
(43) Pub. Date: Jan. 25, 2018

(54) SHAFT–HUB CONNECTION IN PARTICULAR FOR A CONNECTING ROD

(71) Applicant: ECO Holding 1 GmbH, Marktheidenfeld (DE)

(72) Inventor: Dietmar Kaufmann, Tiefenthal (DE)

(21) Appl. No.: 15/694,816

(22) Filed: Sep. 3, 2017

Related U.S. Application Data
(63) Continuation of application No. PCT/EP2016/051396, filed on Jan. 25, 2016.

(30) Foreign Application Priority Data
Mar. 25, 2015 (DE) DE102015104544.3

(51) Int. Cl. F02B 75/04; F16J 7/00; F16D 1/08; F16C 23/10; F16C 7/06

(52) U.S. Cl. CPC F02B 75/045; F16C 23/10; F16C 7/06; F16D 1/0858; F16J 7/00; F16C 2360/22; F16D 2001/102

(57) ABSTRACT

A shaft-hub connection including a lever; and a bearing element of a connecting rod, wherein the bearing element of the connecting rod is arranged in an opening of the lever, wherein the opening is configured so that at least two contact locations are provided between the lever and the bearing element, wherein a clear space is respectively provided between the at least two contact locations, and wherein the opening is offset from the bearing element in the clear space.

### RELATED APPLICATIONS

This application is a continuation of International Application PCT/EP2016/051396 filed on Jan. 25, 3016 claiming priority from German Patent Application DE 10 2015 104 544.3 filed on Mar. 25, 2015, both of which are incorporated in their entirety by this reference.

### FIELD OF THE INVENTION

The invention relates to a shaft—hub connection including a lever and a bearing element inserted into an opening of the lever and a connecting rod with the shaft-hub connection.

### BACKGROUND OF THE INVENTION

In internal combustion engines a high compression ratio has a positive effect upon efficiency of the internal combustion engine. Compression ratio is typically as a ratio of an entire cylinder volume before compression to a remaining cylinder volume after the compression. In internal combustion engines with external ignition, in particular gasoline engines which have a fixed compression ratio the compression ratio may only be selected high enough so that so called “knocking” of the internal combustion engine is prevented under full load operations. However, for the much more prevalent partial load operations of the internal combustion engine, thus at a lower cylinder loading the compression ratio could be selected at higher values without a “knocking” occurring. The important partial load operation of the internal combustion engine can be improved when the compression ratio is variably adjustable. In order to adjust the compression ratio, for example systems with a variable connecting rod length are known.

A connecting rod is known from DE10 2005 055 199A1 where a pivotable lever is inserted into the small connecting rod eye, wherein an eccentrical element is inserted into a central opening of the lever. The eccentrial element is configured to receive a wrist pin. The lever forms a shaft—hub connection together with the eccentrical element, wherein both components include a row of teeth so that the lever and the eccentrical element are connected by a teething. Since the connection is highly loaded during operations of the connecting rod the requirements with respect to fabrication tolerances of the connection partners are high.

### BRIEF SUMMARY OF THE INVENTION

Thus, it is an object of the invention to provide a high load bearing shaft-hub connection with little clearance between the connection components.

It is another object of the invention to provide a connecting rod with the shaft-hub connection described supra.

The objects are achieved by a shaft-hub connection including a lever; and a bearing element of a connecting rod, wherein the bearing element of the connecting rod is arranged in an opening of the lever, wherein the opening is configured so that at least two contact locations are provided between the lever and the bearing element, wherein a clear space is respectively provided between the at least two contact locations, and wherein the opening is offset from the bearing element in the clear space.

Advantageous embodiments and advantages of the invention can be derived from the dependent claims the description and the drawing figures.

A shaft-hub connection is proposed that includes a lever and a bearing element of a connecting rod that is arranged in an opening of the lever, wherein the opening is configured so that at least two contact locations between the lever and the bearing element are formed and a free space is formed between the two respective contact locations where the opening is offset in a controlled manner from the bearing element in the free space.

Offset in a controlled manner means that a planform of the opening of the lever that is configured to receive the bearing element is greater in the offset portions, than the planform of the bearing element. Advantageously the connection is without clearance and has good dynamic properties and facilitates transmitting high torques. Compared to a teething where a respective row of teeth has to be arranged at both joining partners the connection can be fabricated in a much simpler manner. The assembly of lever and bearing element is simplified. The bearing element is in particular an eccentrical element in which a wrist pin is received when the eccentrical element is installed in an internal combustion engine.

According to an advantageous embodiment the opening can be configured polygonal, in particular the opening is not configured circular. Advantageously adjacent polygon sections are separated by a point with a direction change from another polygon section. As a matter of principle the opening can have any planform. A contour can be selected which is advantageous for the planform of the lever and which can consider specifications with respect to space requirement for the connection and the strength of the lever. By selecting a suitable polygon the connection can be configured space saving and dynamically loadable. A self-centering of the two connection partners can also be achieved.

According to an advantageous embodiment the opening can have a triangular plan form, in particular a triangular plan form with rounded corners. Thus, the lines which connect the corners can be cambered. By selecting a suitable placement in the plan form of the lever the connection can be configured particularly space saving. The stability of the lever is not weakened.

According to advantageous embodiment the bearing element can include an outside that is configured as a polygon. Advantageously the bearing element can have a plan form type that matches the plan form of the opening. This facilitates particularly precise positioning of the bearing element and self-centering of the two joining partners. A form locking can also be achieved at the contact locations. The connection is even more stable and bears more load.

According to an advantageous embodiment the bearing element can have a triangular plan form in particular a triangular plan form with rounded corners. Thus, the lines which connect the corners can be cambered. This facilitates particularly precise self-centering of the two connecting partners. Form locking can be achieved at the contact locations. The connection is even more stable and bears more load.

According to an advantageous embodiment the bearing element can have an exterior diameter before insertion into the opening wherein the interior diameter at an identical temperature of lever and bearing element is greater than a clear width of the opening for receiving the bearing element. The connection can be established without clearance.

According to an advantageous embodiment the bearing element can be shrunk into the opening. The connection partners are being pressed together. Advantageously the connection has very little notching. Due to the form locking between the joining partners the connection is without clearance and high torques can be transferred. Thus, the bearing element can be cooled so that the diameter shrinks and the bearing element can be inserted into the warmer lever. During subsequent heating the bearing element expands and safely wedges into the opening.

According to an advantageous embodiment the bearing element can have a ground exterior surface. The exterior surface can be fabricated with high quality and true to shape.

According to an advantageous embodiment the bearing element can be produced from high strength steel.

According to another aspect of the invention a connecting rod is proposed with a shaft-hub connection with a lever and a bearing element arranged in an opening of the lever, wherein the opening is configured so that at least two contact locations between the lever and the bearing element are provided and a clear space is formed between two contact locations where the opening is offset from the bearing element.

The fabrication of the connecting rod is more economical due to the simplified and improved shaft-hub connection of the lever and the bearing element and provides an improved quality of the connection.

### BRIEF DESCRIPTION OF THE DRAWINGS

Additional advantages can be derived from the subsequent drawing description. The drawings illustrate embodiments of the invention. The drawings, the description and the claims include numerous features in combination. A person skilled in the art will advantageously view the features individually and combine them into additional further combinations, wherein:

FIG. 1 illustrates an exploded view of a shaft-hub connection of a prior art connecting rod;

FIG. 2 illustrates a shaft-hub connection according to an embodiment of the invention; and

FIG. 3 illustrates a detail of the shaft-hub connection of FIG. 2 in a top view.

### DETAILED DESCRIPTION OF THE INVENTION

In the drawing figures identical or like components are designated with identical reference numerals. The drawing figures only illustrate embodiments and do not limit the spirit and scope of the invention.

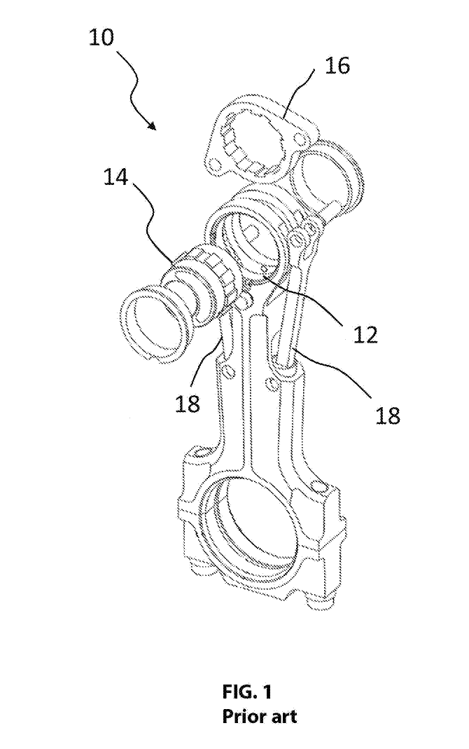

The known connecting rod 10 illustrated in FIG. 1 includes an upper connecting rod bearing eye 12 which is provided for receiving a non-illustrated wrist pin. The wrist pin is pressed into a combustion chamber piston of the internal combustion engine in a typical manner. The upper connecting rod bearing eye 12 is separated by a connecting rod from the large connecting rod bearing eye which is illustrated at the bottom in the drawing figure.

The upper connecting rod bearing eye 12 is pivotable about a pivot axis by a bearing element that is configured as an eccentrical element 14, wherein the pivot axis is arranged offset parallel from a longitudinal axis of the upper connecting rod bearing eye 12. Thus, the eccentrical element 14 is inserted into an opening 12 of a lever 16. In order to produce a connection with as little clearance as possible the lever 16 has an inner row of teeth and the eccentrical element 14 has an outer row of teeth that engage each other. Thus, it is possible to adjust the upper connecting rod bearing eye 12 with respect to its distance from an axis of a connecting rod bearing eye that is arranged at the bottom in the drawing figure and to implement a variable compression in the combustion chamber through the actuation pistons 18 arranged at the upper connecting rod bearing eye 12.

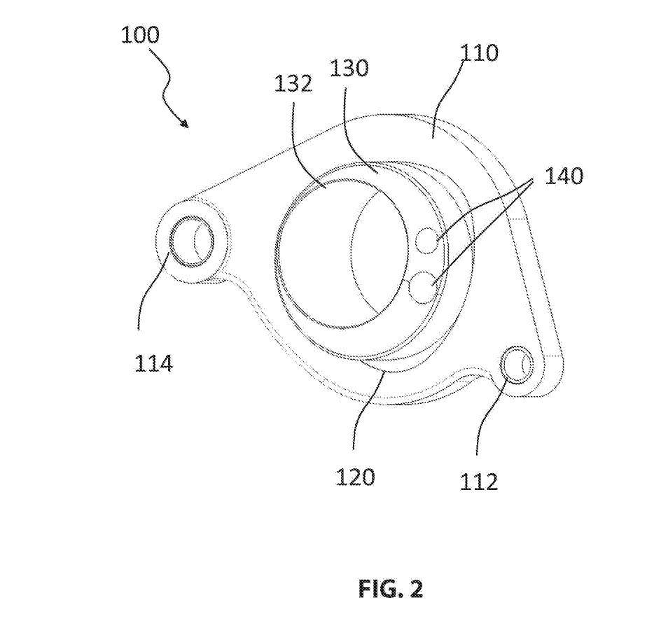

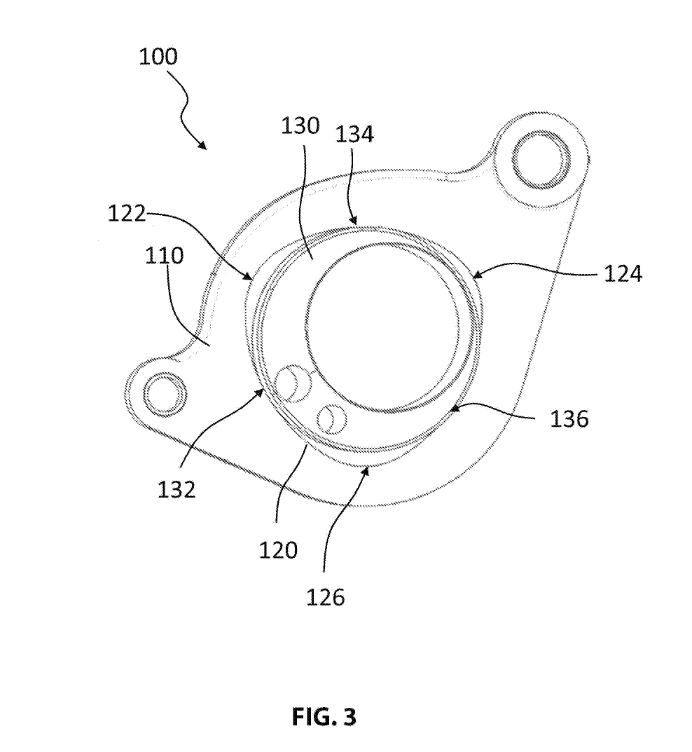

FIG. 2 illustrates a perspective view of a shaft-hub connection 100 according to an embodiment of the invention and FIG. 3 illustrates a top view of the shaft-hub connection 100 of FIG. 2.

The shaft-hub connection 100 includes a lever 110 with an opening 120 and a bearing element 130 which is arranged in the opening 120. A respective opening 112, 114 is arranged on both sides of the opening 120 wherein an actuation piston that is not shown is supported in the openings 112, 114 during normal operations.

The opening 120 is configured as a polygon with a triangular plan form with rounded corners so that the bearing element 130 has three contact locations 132, 134, 136 between the lever 110 and the bearing element 130 and a respective clear space 122, 124, 126 is configured between the contact locations 132, 134, 136 where the opening 120 is offset from the bearing element 130 in the clear space. The bearing element 130 includes an opening 132 for receiving a typical wrist pin, not illustrated. The clear spaces 122, 124, 126 also yield weight savings of the shaft-hub connection 100.

The bearing element 130 that is configured as an eccentrical element also has a polygonal cross section, e.g. with a triangular plan form with rounded corners corresponding to the opening 120. A deviation from a circular shape is not as pronounced as for the opening 12. Small bore holes 140 in the lateral portion of the bearing element 130 provide weight savings for the bearing element 130.

The bearing element 130 has a clear width before insertion into the opening 120 which is greater for an identical temperature of lever 110 and bearing element 130 than a clear width of the opening 120 for receiving the bearing element 130. Advantageously the contour of the opening 120 and of the bearing element 130 is identical at the contact locations 132, 134, 136 of bearing element 130 and lever 110.

The shaft-hub connection 100 facilitates simple assembly. For inserting the bearing element 130 into the opening 120 a temperature difference is generated between the two connection partners wherein the bearing element 130 shrinks relative to the opening 120. When the temperatures of the two connecting partners, lever 110 and bearing element 130 approach each other the bearing element 130 expands and is firmly pressed into the opening 130.

Through the polygonal exterior contour of the bearing element 130 and the polygonal contour of the opening 120 an advantageous self-centering form locking and friction locking with low notching effect is achieved. The shaft-hub connection 100 is configured to transfer high torques with good dynamic properties.

What is claimed is:

1. A shaft-hub connection, comprising:
a lever; and
a bearing element of a connecting rod,
wherein the bearing element of the connecting rod is arranged in an opening of the lever,
wherein the opening is configured so that at least two contact locations are provided between the lever and the bearing element,
wherein a clear space is respectively provided between the at least two contact locations, and
wherein the opening is offset from the bearing element in the clear space.

2. The shaft-hub connection according to claim 1, wherein the opening is configured polygonal.

3. The shaft-hub connection according to claim 1 wherein the opening has a triangular plan form or a triangular plan form with rounded corners.

4. The shaft-hub connection according to claim 1, wherein the bearing element includes an outside that is configured polygonal.

5. The shaft-hub connection according to claim 4, wherein the bearing element has a triangular cross section or a triangular cross section with rounded corners.

6. The shaft-hub connection according to claim 1,
wherein the bearing element has an unsupported exterior diameter when the bearing element is not supported in the opening, and
wherein the unsupported exterior diameter is greater than an inner width of the opening for receiving the bearing element when the lever and the bearing element have an identical temperature.

7. The shaft-hub connection according to claim 1, wherein the bearing element is shrunk into the opening.

8. The shaft-hub connection according to claim 1, wherein the bearing element has a ground outer surface.

9. The shaft-hub connection according to claim 1, wherein the bearing element is made from a high strength steel.

10. A connecting rod with a shaft-hub connection according to claim 1.
